(19) United States
(12) Patent Application Publication
(10) Pub. No.: US 2015/0243258 A1
(43) Pub. Date: Aug. 27, 2015

(54) TRANSPARENT GIFT CARD FOR OVERLAYING A DIGITAL DISPLAY

(71) Applicant: Disney Enterprises, Inc., Burbank, CA (US)

(72) Inventor: ERIC MICHAEL HOWE, Lowell, MA (US)

(73) Assignee: Disney Enterprises, Inc., Burbank, CA (US)

(21) Appl. No.: 14/187,560

(22) Filed: Feb. 24, 2014

(51) Int. Cl. G09G 5/377; G06T 11/00

(52) U.S. Cl. CPC G09G 5/377; G06T 11/001

(57) ABSTRACT

A visual display assembly is provided for allowing an operator of digital device such as a smartphone to have an interactive experience with their display. The assembly or apparatus includes a digital device with a display screen and an overlay card for positioning over the display screen. The overlay card, which may take the form of a gift card, a debit card, a credit card, an access card, an ID card, or the like, includes a light-blocking region and a viewing window that is at least translucent to light adjacent the light-blocking region. Further, the digital device is selectively operable to display an image on the display screen viewable through the viewing window of the overlay card. The assembly includes a web server accessible with the digital device to download the image onto the digital device, and the image is provided by the digital device playing video content.

### BACKGROUND

1. Field of the Description

The present invention relates, in general, to digital display methods and devices such as smartphones, tablets, personal digital assistants, digital readers, and the like, more particularly, to a method and corresponding apparatus for allowing an operator of a digital device with a display or display screen to interact with imagery displayed to create new viewing experiences.

2. Relevant Background

Today, with advances in technologies and the lowering of prices, nearly everyone uses or at least has access to digital devices that are adapted to perform numerous tasks. For example, many digital devices are designed to perform one main task such as to act as a cellular telephone, to allow an operator to read books and other publications that are in digital form (e.g., electronic books or eBooks), to take digital photographs and videos, and the like. Further, though, it has been common for the digital device to perform many other tasks including wirelessly accessing the Internet to retrieve or view information, and, to this end, the digital device includes wireless communication components and also one or more processors, data storage or memory, and a software suite including an operating system.

The software suite includes applications such as a browser (e.g., a full HTML web browser) to access the Internet and its voluminous data, but many other applications or “apps” (or “mobile apps”) may be included to perform other tasks such as to provide maps (with many mobile digital devices including a GPS navigation unit), to play media such as music and movies, to access email, and so on. Each of the digital devices typically includes one or more screens, which may also be touchscreens, to display data and images and to allow the operator of the devices to interact with their devices including initiating and using all of their apps. Commonly used digital devices include smartphones, digital readers, and a wide variety of portable or mobile computers adapted for wireless communications (access to the Internet via WiFi networks) such as tablets, laptops, pads, handheld game consoles and the like (herein, all of these portable computers may be labeled more simply as “digital devices”).

Many technologies are quickly embraced and used widely by many in the public, and these people may be considered early adopters and the early majority. However, there are many people who only adopt technologies such as smartphones and digital readers slowly and with many reservations, and these people may be considered the late majority or even laggards. For example, augmented reality (“AR”) has been available for use in video gaming, but only a relatively small percentage of gamers make use of this technology. Similarly, there are many digital devices that can readily be adapted for interactive uses, but many users only make use of a very small percentage of their device's functions such as using their smartphone only as a phone and a camera. This limited use and interaction with digital devices is very prevalent within the late majority.

Hence, there remains a need for methods and products to encourage and assist owners and operators of digital devices such as smartphones, digital readers, and mobile computers to interact with their digital devices. Preferably, it would be useful for these methods and products to be designed to cause the digital device operators to interact with and more fully enjoy information and/or images, such as still or video imagery, displayed on the display screen of a digital device.

### SUMMARY

It was recognized that many people are nervous about using their digital devices, such as smartphones, tablets (or other mobile computers), and digital readers, in new and different ways. This reluctance to experiment is particularly pronounced in the late majority of adopters or users of technology. The inventor determined that digital device operators including those in the late majority will more readily interact with a technology such as their smartphone and its display capabilities when the interaction is explained in a straightforward and easy to access manner and when the steps to achieve full interaction are few. This is in contrast to early adopters and the early majority of technology users who may be more willing to simply try a new app or play with their device's interface to find functions even if they often will make mistakes.

With all of this in mind, an interactive display assembly and method are described that facilitate interaction with a digital device and its display screen. Briefly, the assembly includes an overlay card that may be distributed or provided to device operators in the form of a gift card, a debit/credit card, a promotional card, or the like. The overlay card is sized and shaped to match the size and shape of a display screen in some embodiments while in other cases the overlay card may only cover a portion or fraction of a display screen. For example, the overlay card may take the size and shape of a conventional gift or credit/debit card, which matches (at least approximately such as within about 20 percent in each dimension) the size and shape of many smartphone displays. The overlay card includes one or more translucent to transparent regions along with translucent or opaque regions.

The display assembly also includes a digital device, and, in use to provide an interactive display, the overlay card is placed over the digital display or display screen of the digital device. The translucent to transparent regions of the overlay cards act as viewing or display windows to corresponding portions (e.g., regions of the digital display mapped to the transparent regions of the cards to display selected images through these display windows). The display assembly further includes a server accessed by the digital display to serve the images (e.g., a still or video image) to the digital device with the overlay card placed over the display screen.

In an exemplary display method or use of the display assembly, interactivity is encouraged because the digital device operator only has to know how to operate their digital device to access the image server. This may involve accessing their device's web browser and typing a web or Internet address (e.g., a Uniform Resource Locator (URL) when using HTTP). The image server may display a page providing instructions to the device operator on how to complete interaction, and this may include screen instructions on how to select an image (e.g., a video) and to place their overlay card over their display screen after image selection (e.g., select video and place their gift card on the front of their smartphone).

The viewing windows of the overlay card allow the device operators to see a scene through the overlay card. The adjacent regions of the card may include display elements (e.g., printed scene/set images that are opaque or at least not transparent) that match the scene being displayed through the window of the overlay card (e.g., a fireworks or light show video displayed in a display window shaped like the sky or space behind a set including building or scenery provided by the adjacent, non-transparent regions/portions of the overlay card). In some embodiments, the digital device may include an application or app that allows the digital device to read a code printed on the overlay card to access the server (or to simply retrieve the images such as a video) rather than requiring the operator to type in a web address (e.g., a barcode such as a matrix or two-dimensional barcode (that may take the form of a Quick Response (QR) code often readable by many smartphones) may be printed on a gift card that the digital device may scan and communicate scanned/read data to the image server).

More particularly, a visual display assembly is provided for allowing an operator of digital device such as a smartphone to have an interactive experience with their display. The assembly or apparatus includes a digital device with a display screen and an overlay card for positioning over the display screen. The overlay card, which may take the form of a gift card, a debit card, a credit card, an access card, an ID card, or the like, includes a light-blocking region and a viewing window that is at least translucent to light adjacent the light-blocking region. Further, the digital device is selectively operable to display an image on the display screen viewable through the viewing window of the overlay card.

In some cases, the viewing window is adapted to magnify the displayed image. In the same or other cases, the viewing window is adapted to filter light from the display screen whereby appearance of the displayed image is modified when viewed through the viewing window. The viewing window may have a frosted treatment to modify the displayed image when viewed through the viewing window.

In some implementations, the assembly or apparatus includes a web server accessible with the digital device to download the image onto the digital device, and the image is provided by the digital device playing video content (e.g., a media player on the device plays a digital video file obtained over a wireless communication network from a web server). In such implementations, the video content can be selected by the web server based on the overlay card (e.g., determine which overlay card is in use and select a video file adapted to map a displayed image to the viewing window's size, location, and other features (e.g., its filtering capabilities). In other cases, though, the video content can be selected by the web server in response to user input indicating selection of one of a set of videos from a list displayed on the display screen of the digital device.

In some preferred embodiments, the overlay card has a size and shape substantially matching a size and shape of the display screen. Further, the overlay card may have a body or layer formed of substantially transparent material and then further include a light-blocking layer formed of a substantially opaque material attached to a surface of the body. In these implementations, the light-blocking layer may have a light-blocking region and further have a void or hole whose boundaries define outer edges of the viewing window (e.g., the material of the light-blocking layer may only extend over portions of the surface of the transparent body).

In some embodiments, one or more functions of the digital device are triggered by operations of the digital device to display the image on the display screen. In the same or other embodiments, during the display of the image on the display screen, the digital device receives user input and, in response, alters the display of the image (e.g., to provide a type or form of augmented reality). While not limited to a particular digital device or overlay card, some embodiments of the display assembly are practiced by using a smartphone for the digital device and a gift card, a debit card, a credit card, an access card, or an ID card for the overlay card.

### BRIEF DESCRIPTION OF THE DRAWINGS

FIG. 1 is a functional block diagram of an interactive display system of the present description illustrating the use of digital devices along with overlay cards (e.g., gift cards or the like) to allow users/operators to interact with their displays (or display screen) and images displayed on such displays;

FIGS. 2A and 2B illustrate a perspective, exploded view of an overlay card and a top view of the assembled card of FIG. 2A, respectively;

FIGS. 3A and 3B illustrate two stages or steps in an interactive display method of the present description showing use of an exemplary overlay card with a digital device (e.g., a smartphone); and

FIG. 4 is a flow diagram for an interactive display method of the present description.

### DETAILED DESCRIPTION

Briefly, the present description is directed toward a method (and corresponding devices and systems) for facilitating operator or user interaction with technology. More specifically, a display method is described that involves an operator of a digital device such as a smartphone, a mobile computer such as a tablet, pad, laptop, handheld, or the like, or digital reader to selectively display images on the display or display screen of their digital device. The displayed images are chosen to map to or correspond to a previously obtained overlay card such as a gift card, and the method continues with the device operator placing the overlay card on top of or over the digital display. The displayed images may be accessed or retrieved from the digital device memory/data storage or may be accessed via communications between the digital device and a web server (or similar device), e.g., the operator may enter a web address to obtain a video matched to a particular overlay card.

The overlay card is formed or fabricated so as to include light-blocking regions (e.g., layers of ink or applied material such as paper or plastic that are translucent-to-opaque to light) and, significantly, to also include one or more light-transmitting regions (e.g., windows or regions of the card that are transparent (or at least translucent) to light). The overlay cards may be sized fully or only partially cover the digital display and the displayed image(s), but a portion of the imagery is displayed through the windows or light-transmitting regions for concurrent viewing of images/information provided on the light-blocking region(s). For example, the light-blocking region may include images of a wintery mountain range and the window may be positioned relative to the light-blocking region to be the sky above the mountains. Then, the display images may be provided by a video showing stars and also snow falling upon the mountains. In this manner, the overlay card allows the operator to interact with their digital device and the images displayed via its display screen.

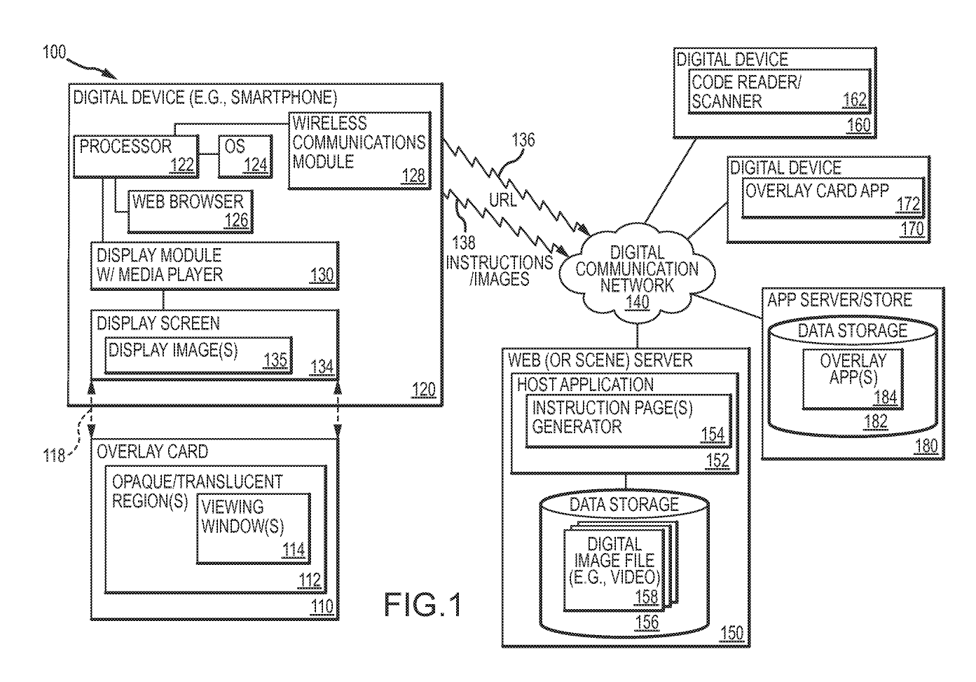

FIG. 1 illustrates an interactive display system 100 according to one embodiment of the present description. The system 100 includes a digital device 120, which may take the form of a smartphone, a mobile computer (e.g., a tablet, a pad, a laptop, a handheld, a game console, or the like), a digital reader, or other electronic device. The digital device 120 is shown to include a processor 122 that runs an operating system (OS) 124, and the digital device 120 further includes a wireless communication module 128 that allows the digital device 120 to communicate in a wireless manner with a digital communications network 140 (e.g., to access the Internet and servers linked to the Internet). A web browser 126 is also provided on the digital device 120 to facilitate display of pages/content received from the digital communications network 140.

Further, the digital device 120 includes a display module with associated media players 130, which functions to operate a display or display screen 134 such as to display web pages or Internet-obtained data and to display media content such as videos, still photos, audio, and so on. The size and configuration of the display screen 134 may vary widely to practice the system 100, but, in some cases, the display screen 134 may have a size and shape that is similar to that of a conventional gift card (or debit/credit card). For example, the display screen 134 may be rectangular in shape and be about 1 to 2 inches in width and 2 to 4 inches in length.

The system 100 also includes an overlay card 110 that is physically separate from the device 120 but is designed to mate with and at least partially cover the display screen 134 (or its planar outer surface which may include a protective glass/plastic layer such that the card 110 is placed onto this protective layer over the display screen 134 and not directly onto the screen 134 itself). The overlay card 110 may take the size and shape of conventional gift cards, credit cards, debit cards, ID cards, and the like. The overlay card 110 typically is formed of plastic and is configured to include a light-blocking region(s) 112 that is translucent-to-opaque to light including the light transmitted outward from the display screen 134. For example, a paper or plastic layer of material or ink layer may be attached to the front and/or back surfaces of the overlay card 110 to provide the light-blocking region(s) 112 as is common with conventional gift and credit/debit cards.

However, the overlay card 110 also includes one or more light-transmitting regions or “viewing windows” 114 that are transparent-to-translucent to light including the light transmitted outward from the display screen 134. The viewing window 114 may be provided adjacent to the light blocking region 112 or may be provided within the region 112, with the region 112 acting to frame images viewed on the display screen 134 through the window 114. The viewing window may be provided by forming the card 110 with a body of clear material such as clear (or at least translucent) plastic and then layer applying one or more layers to provide the light-blocking regions. The light-blocking regions 112 may be sized and shaped so as to define the size, shape, and locations of the viewing windows 114, e.g., the absence of material used to provide the light-blocking region 112 coincides with the location of the viewing windows 114.

In use, an image or images 135 are displayed upon the display screen 134, and the overlay card 110 is concurrently (or previously) placed upon the display screen 134. As a result, the light-blocking regions 112 block a portion of the light associated with the displayed image 135 while the viewing window 114 allows all or a portion of the light associated with the displayed image 135 to pass through the overlay card 110. An operator of the system 100 looking at their display screen 134 is, thus, able to see imagery/information provided in the translucent-to-opaque regions 112 and also to see the displayed image 135 through the viewing window 114. The displayed image 135 may include alignment markers instructing the operator where and in what orientation to place the overlay card 110 over the display screen 135 so as to properly align the regions 112, 114 with the displayed image 135. In other cases, the operator may simply place the “top” of the overlay card 110 at the “top” of the display screen 134, with the “tops” being evident from the design of the device 120 and card 110 (e.g., rotate the digital device into landscape or lengthwise viewing when the light-blocking region 112 is printed with a landscape-arranged image or the like).

Further, in use, the operator of the digital device 120 may act to use their web browser 126 to access the network 140 and to enter a web address (e.g., a URL) to request the displayed images 135. The web address/URL 136 may be supplied within the opaque regions 112 of the overlay card (or this web address may be obtained in other ways such as by promotional materials provided to the user with the purchase of the gift card 110). The system 100 further may include a web (or image/scene) server 150 communicatively linked to the network 140. The web server 150 includes a host application 152 that acts to serve pages and information to the digital device 120 as shown at 138. To this end, the host application 152 may use an instruction page(s) generator 154 to generate pages and/or instructions that are viewable via pages 138 by the operator 120 in the display screen 134 (e.g., before the images 135 are displayed or as a preliminary image 135).

The server 150 includes data storage 156 storing a plurality of digital image files 158 such as videos (or still images) that may be requested or retrieved by an operator of the device 120 via input through the web browser 126. The images 158 are then transmitted as shown at 138 over the network 140 and wireless communication link established by wireless communication module 128 (e.g., by communications with wireless networks or WiFi access points or the like), and the display module 130 acts to operate the display screen 134 to display the images 135, which may be partially covered/blocked from view by the light-blocking regions 112 and partially or wholly visible through the viewing window 114 by the device operator (or others viewing the device 120).

The digital device 120 provides one useful implementation of a device for providing an interactive display experience. Other implementations may be used, though, to interact with the digital device and its display (or displayed images on the display). For example, a digital device 160 may be provided in the system 100 that includes components such as those shown for device 120 (not shown in FIG. 1 but understood). The device 160 further includes a code reader and/or scanner 162 that is adapted to read a code such as a bar code placed on the overlay card 110 such as in one of the opaque regions 112. For example, the printed/provided code on card 110 may take the form of a QR code that the scanner 162 may read to obtain the web address of the server 150 such that the operator does not have to type in/enter a URL or the like. The device 160 may automatically access the server 150 or the operator may have to instruct the device such as through a web browser to take this step to obtain instructions/images (like data 138 provided to device 120).

The system 100 may also include a digital device 170 configured similar to device 120 but also including and running an overlay card app 172. The device 170 may access an app server or store 180 via the network 140 to request, purchase/obtain for free, and download from data storage 182 one or more overlay apps 184 to provide the overlay card app 172. The app 172 may function to provide the overlay/interaction instructions and images to the device 170 provided by instructions/images 138 by web server 150 (e.g., take place of web server 150). In other cases, the app 172 may provide instructions on how to use the overlay card 110 to interact with a display screen and displayed images but the app 172 may function to retrieve image files such as files 158 provided over the network 140 rather than storing images on device 170.

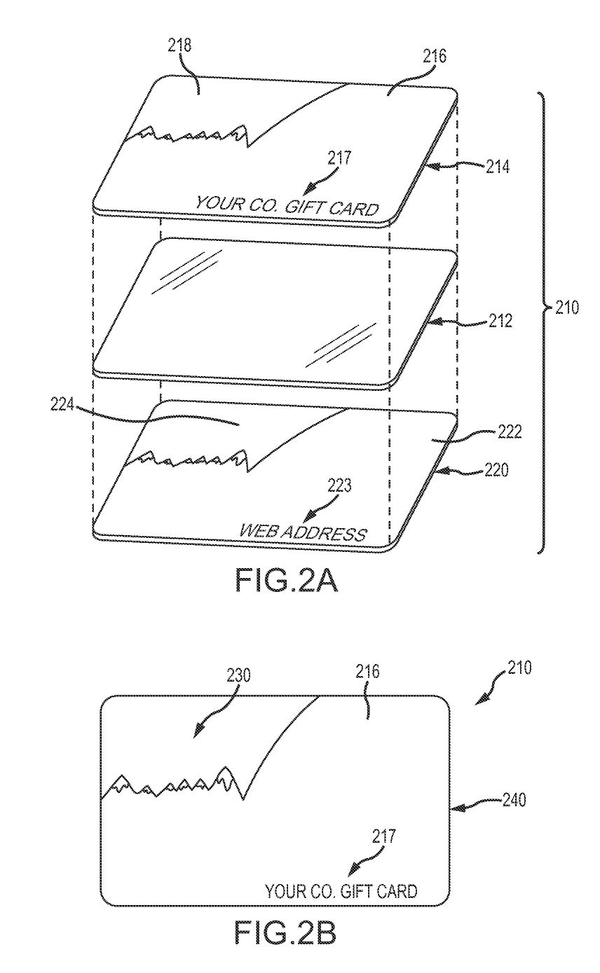

FIGS. 2A and 2B illustrate a perspective, exploded view of an overlay card 210 and a top view of the assembled card 210 of FIG. 2A, respectively. The overlay card 210 is formed in this example by providing a transparent (or at least translucent) body or base layer 212, which may be formed of thin layer of plastic (e.g., less than about 1 to 2 millimeters). The card 210 further includes an upper light-blocking layer 214 that is formed of a thin layer of translucent-to-opaque material such as a printed layer/film of ink or a layer of plastic or paper. The upper light-blocking layer 214 includes a light blocking region 216 that may include one or more images selected to provide foreground or other scenery that matches or is suited for viewing with images (e.g., movies/videos) displayed through a void or space 218 where no light blocking material is provided (or this space 218 may be provided with transparent material in some embodiments). Text/information elements 217 may also be provided in the light-blocking region 216, e.g., to provide promotional information such as identifying the overlay card 210 as a gift card for use in purchasing goods and/or services from a particular company.

The card 210 also includes a lower light-blocking layer 220 that again is formed of a film/layer of ink or a layer of plastic, paper, other light blocking (or translucent) material, or a combination of two or more of such materials. The layer 220 may be configured with a light blocking region 222 of similar size and shape as the region 216 and with a void/space 224 (or a region of transparent-to-translucent material) matching the void/space 218. The lower or back light-blocking layer 220 may be used to present information/data to the user (how to use the card to purchase goods/services as well as to use the card 210 as an interactive overlay on a digital device's display such as “Scan QR Code or visit InteractiveCard.com” or the like), to provide a bar code that can be scanned to obtain a web address or access a web server, and/or to provide a web address (e.g., a URL) as shown at 223 (although this would be printed in mirror image format to be readable when applied to the back surface of the transparent-to-translucent body/base layer 212).

To assemble the card 210, the upper/front light-blocking layer 214 is applied to an upper/first surface of the transparent-to-translucent body 212, and the lower/back light-blocking layer 220 is applied to a lower/second surface of the transparent-to-translucent body 212 (i.e., opposite to the upper/front light-blocking layer 214). The voids/spaces 218, 224 and the regions 216, 222 are aligned to be opposite each other in the assembled card 210 as shown in FIG. 2B.

In this way, a viewing window 230 is provided adjacent a light-blocking region 240 with the window 230 being provided by a combination of the voids (or translucent-to-transparent regions) 218, 224 in the upper and lower layers 214, 220 with the translucent-to-transparent body 212. The light-blocking region 240 is provided by a combination of the light blocking regions 216, 222 of the upper and lower light-blocking layers 214, 220. Note, some embodiments of the card 210 may include only one of the layers 214, 220 to provide a window 230 and a light-blocking region 240 (e.g., the front layer 214 may be omitted with imagery/scenery provided on a surface of the back layer 222 abutting the back surface of the body 212 (e.g., the layer 214, 220 may be two sided rather than simply having one side being a single color such as black)).

The layer 212 may be clear (no or little color) and be translucent-to-transparent. In other cases, it may be desirable to achieve a visual effect with the viewing window so as to modify the displayed image (or the light emitted from the display screen). For example, the body 212 may be formed of a colored material or be tinted to have one or more colors. In this way, the viewing window 230 acts as a filter to change color or appearance of the displayed image on a digital device's display. In other cases, the body 212 or the portion used for viewing window 230 may be adapted to function as a magnifying lens such that images displayed on an overlain display are magnified by a desired magnification (magnifying power such as 2× up to 10× or more). In other cases, the body 212 may be configured to provide a frosted glass or waxy or other visual treatment so as to change or modify what is displayed upon the device's display screen when it is viewed through the window 230 compared to when it is viewed without the overlay card 210.

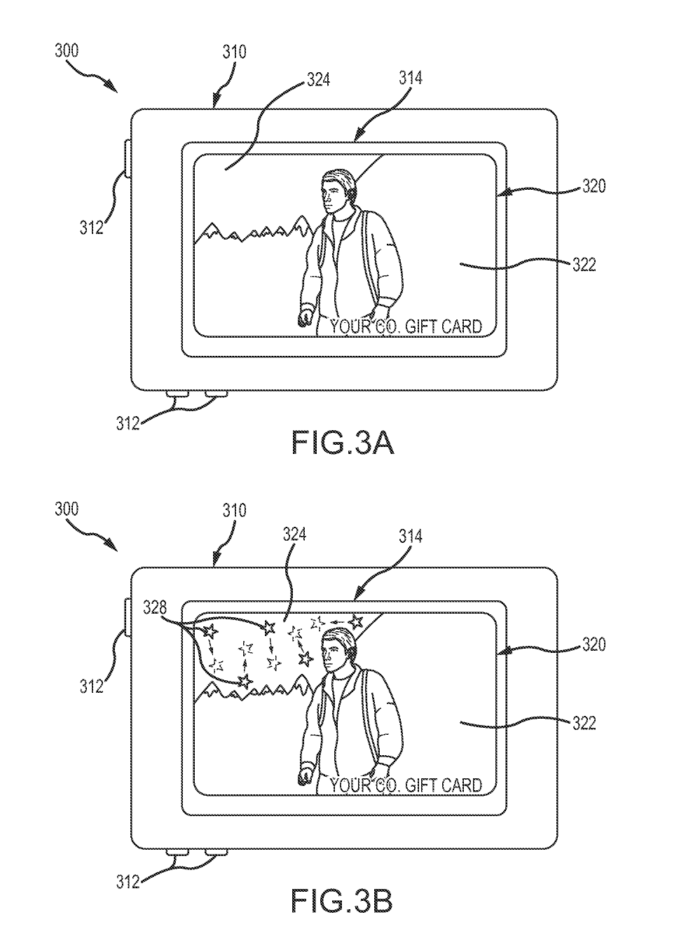

FIGS. 3A and 3B illustrate views of portions of an interactive display system 300 in two stages of operation. As shown, a digital device 310 such as a smartphone is included in the system 300 and includes several input devices (buttons along the side of the device housing/body) 312. The digital device 310 also includes a display screen 314 that may also be a touchscreen and/or microdisplay (e.g., a liquid crystal display (LCD) or the like) as is the case of many mobile computers, smartphones, and digital readers. As shown, an operator (not shown) has placed an overlay card 320 over a portion of the exposed surface of the display screen 314. For example, alignment marks may be provided to assist the operator in proper placement of the card 314 over or upon the screen to align the window 324 with a later displayed image (e.g., a video). The overlay card 320 includes a translucent-to-opaque region 322 including scenery or other image elements chosen to correspond with later displayed images through the transparent-to-translucent viewing window 324 (whose boundaries, shape, and size are defined by adjacent edges or boundaries of the light-blocking region 322).

As discussed above, prior to placement of the card 320 on the screen 314. The operator typically will have entered a web address into a data entry box in a web browser interface displayed in screen 314 or used the device 310 to scan a code on the card 320. This causes the device 310 to communicate with a web server wirelessly. The web server may include a host application that functions to display images that can be accessed by the operator (e.g., a listing of videos available to view with the overlay card 320). Upon a selection by the operator via inputs 312 or touchscreen 314, the host application may then display an instructional screen or screen to facilitate effective interaction. For example, the host application may cause “Play Video” with a play/forward button on the screen 314 and, once play is selected by the user, cause “Place Card on Device Screen” (optionally with alignment marks for the card).

After a small delay (such as 1 to 5 seconds or the like), the host application on the server may cause via the device's web browser and/or media player the selected video to be played. This causes a video or other image to be displayed in an area of the display screen that is mapped to the viewing window 324 when the card 320 is properly positioned on top of or covering the screen 314. FIG. 3B illustrates this image displaying step with a displayed image 328 such as a video or movie clip being viewable through the viewing window 328 while being blocked by the adjacent light-blocking region 322.

In some embodiments, the selected image may be an image provided by the operator and stored on the device 310 or on the web server. For example, a recording may be made of the operator performing or participating in an activity such as going on an amusement park ride. This video may then later be selected by the user for display on their digital device. The overlay card 320 may be configured with light-blocking region 322 that shows portions of the ride or associated scenery, and the viewing window 324 may be shaped and sized to suit the playback of the recorded video (e.g., show the opening of a tunnel through which a ride vehicle containing the operator passes).

In some embodiments, the display system 300 is adapted to provide a form of augmented reality. For example, input from the digital device 310 may be used to change how the selected image is displayed by the digital device 310. In some cases, the sound, motion, or other input buttons 312 of the device 310 may be processed when the image 328 is being displayed to modify the displayed image 328 in real time. In other implementations, the displayed image (or media content downloaded by the web server) may initiate functions of the digital device 310 to be performed during display of image 328. For example, an app on the device 310 may process the received digital file for image 328 and determine that a sound file should be retrieved and concurrently played or determine that light functions should be triggered (such as to increase or decrease illumination levels of lighting for screen 314 or cause the flash of a camera of the device 310 to be triggered) to achieve a desired interactive display experience or visual/audio effects.

In some cases, the devices vibration motor or devices (e.g., software and devices used to cause a smartphone, video game, or the like to rumble or vibrate) is triggered by what is going on in the scene. For example, a gift card with a volcano on it can be overlaid onto the device, and the phone can vibrate to go along with the sounds and sights of the volcanic eruption so as to be simulating the force of the eruption. Another example would be a thunder storm, the flash would simulate the lightning, and the vibration would simulate the sound waves/shaking of the thunder (accompanied by the actual sound of thunder through the speaker of the digital device).

In other preferred embodiments, it may be useful for the overlay car to be slightly elevated (e.g., spaced apart from the device's display screen by 0.1 to 1 inch or more). In such implementations, the overlay card may be held over the display screen a distance or supported over the display such as by a folded gift card carrier or the like supplied with the overlay card to consumers/users of the digital devices. The folded gift card carrier or other structure may take on a U-shaped housing (with two short end walls or legs and a larger central member or spanning member holing the overlay card in a manner that does not block the viewing window) that elevates the card about a half an inch or so above the screen. This overlay card support or housing is useful as it adds some depth to the scene and may be designed to contribute to the displayed imagery (e.g., to have a unique look, e.g., with a castle imagery gift card and video of one implantation the depth adds to the imagery by providing enhanced 3D effects).

Hence, the present description covers use of overlay cards that are placed directly onto a device's display screen, that are held by the user's a range of distances away from the display screen (e.g., the user may be prompted with GUI instructions or with images or text on the overlay card itself to hold the overlay card a distance in a predefined range of separation distances such as 0.25 inches on either side of a preferred spacing for the card images and the displayed still or video images on the display screen (e.g., 0.25 to 0.75 inches or the like), and that are supported a predefined distance from the display screen by an overlay card support or housing (itself being designed to allow light from the display screen to pass through to the viewing window of the overlay card).

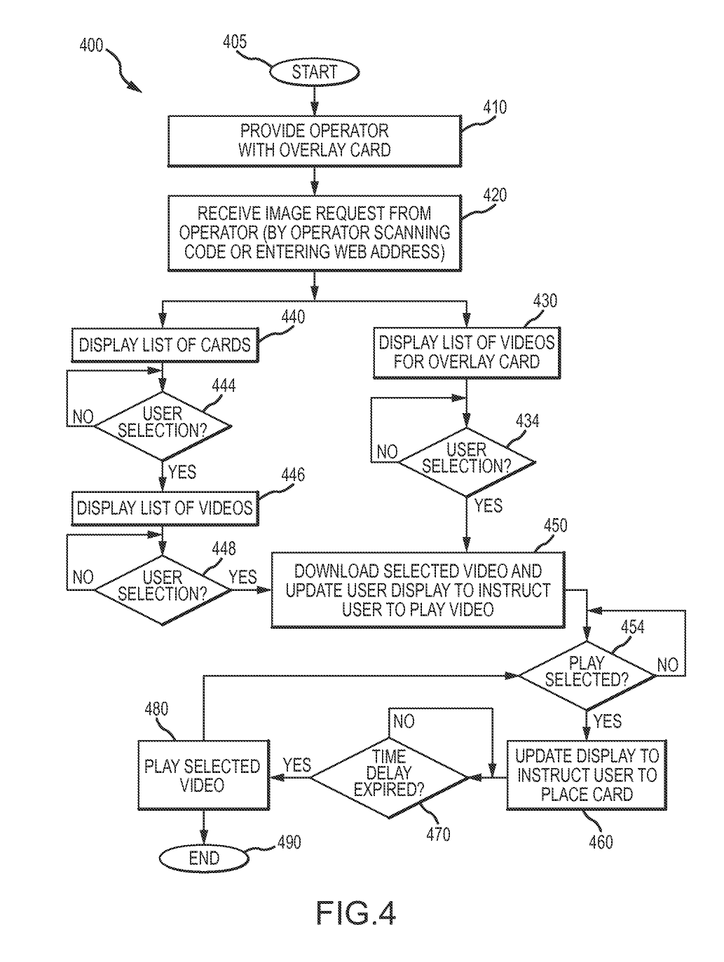

FIG. 4 illustrates a flow diagram or algorithm used to implement one interactive display method 400 of the present description, such as may be implemented with the system 100 of FIG. 1 with the cards and devices shown in FIGS. 2A-3B. The method 400 starts at 405 such as with choosing designs for one or more overlay cards (e.g., gift cards, credit cards, debit cards, ID cards, and the like), which may involve choosing image elements for inclusion in the light-blocking regions and choosing a size and shape for the viewing window and whether the viewing image will be clear, tinted with color, magnifying, frosted/waxy, or a combination of two or more of these effects (e.g., an embodiment may have one layer of an overlay car that is a tinted color and another with a magnifying treatment). Further, step 405 may involve selecting one or more images (e.g., video content) to be displayed with the overlay card through the designed viewing window, and providing a web server on a digital communications network that is adapted for serving interaction instructions and also the set of videos or other images to those that access or visit a web address serviced by the server.

The method 400 continues at 410 with providing an operator/user of a digital device with an overlay card such as by offering the overlay card in the form of a gift card for purchase to the operator/user. At step 420, the method 400 continues with receiving an image request or an interactive display request from an operator. For example, the operator may enter a web address into their device's browser, with the address provided typically on the overlay card obtained in step 410, or the operator may use their device to scan a bar code (e.g., a QR code) to obtain this web address.

The method 400 may involve the web server processing the request and determining whether there are one or more overlay cards in circulation to operators or to determine which card is associated with the request at 420. If the card is known or only one card is in circulation, the method 400 may continue at 430 with the web server retrieving and displaying on the display screen of the digital device (source of the interaction request in step 420) a list of videos (or other images) that can be chosen for use with the particular overlay card. For example, the operator may be able to select a day scene or a night scene for display in their viewing window, select a video they recorded previously, select a starry scene, a light show scene, or a firework scene for use with their card, or the like.

In some embodiments, videos may be provided with a downloaded display module/app (e.g., app 130 shown in FIG. 1) while in other cases the video may be a user-generated video or include user-provided or input content (e.g., be a video provided with the app or via the web server but also include user content such as a still image or their video so as to personalize the displayed imagery/video through the viewing window). Such user-provided content typically could be uploaded to the web server where a combination video would be created (or this may be done on the digital device itself with the downloaded display module/app), and, in this way, the videos listed in step 430 (and 446) are not limited to fully prerecorded videos but may include videos that are wholly user-provided content or include user-provided content.

Once a video is selected at 434, the method 400 continues at 450 with the web server downloading the selected video to the digital device and then updating the display screen to instruct the user to play video (or offering this as a choice such as with a play button or the like). If play selection is received/determined at 454, the method 400 continues at 460 with the web server (or an app running on the digital device) updating the display screen to instruct the user to place the overlay card over the display screen of the display device. The method 400 may enforce a time delay such as 1 to 5 seconds for the operator to perform this task, and step 470 determines when this pause or overlaying time period has expired after play video selection (or after instructing the user to place their card at 460). When expired, the method 400 continues at 480 with the media player of the digital device acting to play the selected video (or other selected image) on the device's display screen (or digital display). The method 400 then ends at 490.

In some cases, the method 400 may involve the web server or its host application not making a card determination (associating a request at 420 with a particular card) and the method 400 then may continue at 440 with the host application causing a web page to be served to the requesting digital device. This web page may include a list of overlay cards (e.g., one-to-many different overlay cards with different viewing window shapes/sizes or effects and/or with different light-blocking regions may be in circulation at any given time), and the user may provide input via their touchscreen or other input devices to indicate which overlay card they will be using in this interactive display session.

When card selection is received at 444, the method 400 may then continue with the host application of the web server retrieving a listing or set of videos (or other images) available on the server for use with the selected overlay card, and this listing is displayed on a served page on the digital device's display screen. The user/operator may operate their display device to select one of the videos/images in the list for viewing through their overlay card. When video/image selection is received at 448, the method 400 may then continue with steps 450-490 as discussed above.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

Several means are available to implement the systems (such as system 100 of FIG. 1 and device 310 in FIGS. 3A and 3B) and methods (such as method 400 of FIG. 4) discussed in this specification. These means include, but are not limited to, digital computer systems, microprocessors, application-specific integrated circuits (ASIC), general purpose computers, programmable controllers and field programmable gate arrays (FPGAs), all of which may be generically referred to herein as “processors.” For example, in one embodiment, signal processing may be incorporated by an FPGA or an ASIC, or alternatively by an embedded or discrete processor. Therefore, other embodiments include program instructions resident on computer readable media which when implemented by such means enable them to implement various embodiments. Computer readable media include any form of a non-transient physical computer memory device. Examples of such a physical computer memory device include, but are not limited to, punch cards, magnetic disks or tapes, optical data storage systems, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to, computer-executable instructions executed by computer system processors and hardware description languages such as Very High Speed Integrated Circuit (VHSIC) Hardware Description Language (VHDL).

I claim:

1. An apparatus for providing an interactive display experience, comprising:
a digital device with a display screen; and
an overlay card for positioning over the display screen, wherein the overlay card comprises a light-blocking region and a viewing window that is at least translucent to light adjacent the light-blocking region and wherein the digital device is selectively operable to display an image on the display screen viewable through the viewing window of the overlay card.

2. The apparatus of claim 1, wherein the viewing window is adapted to magnify the displayed image.

3. The apparatus of claim 1, wherein the viewing window is adapted to filter light from the display screen whereby appearance of the displayed image is modified when viewed through the viewing window.

4. The apparatus of claim 1, wherein the viewing window has a frosted treatment to modify the displayed image when viewed through the viewing window.

5. The apparatus of claim 1, further comprising an overlay card support supporting the overlay card a predefined separation distance apart from the display screen, wherein the overlay card support is configured to transmit light from the display screen associated with the displayed image through the viewing window of the overlay card.

6. The apparatus of claim 1, further comprising a web server accessible with the digital device to download the image onto the digital device and wherein the image is provided by the digital device playing video content.

7. The apparatus of claim 6, wherein the video content is selected by the web server based on the overlay card or the video content is selected by the web server in response to user input indicating selection of one of a set of videos from a list displayed on the display screen of the digital device.

8. The apparatus of claim 1, wherein the overlay card has a size and shape substantially matching a size and shape of the display screen.

9. The apparatus of claim 1, wherein the overlay card comprises a body formed of substantially transparent material and a light-blocking layer formed of a substantially opaque material attached to a surface of the body and wherein the light-blocking layer comprises the light-blocking region and further comprises a void whose boundaries define outer edges of the viewing window.

10. The apparatus of claim 1, wherein one or more functions of the digital device are triggered by operations of the digital device to display the image on the display screen.

11. The apparatus of claim 1, wherein, during the display of the image on the display screen, the digital device receives user input and, in response, alters the display of the image.

12. The apparatus of claim 1, wherein the digital device comprises a smartphone and wherein the overlay card comprises a gift card, a debit card, a credit card, an access card, or an ID card.

13. An apparatus for providing an interactive display experience through the use of display of a digital device operating to display a video image on the display, comprising:
an overlay card for positioning over the display screen, wherein the overlay card comprises a light-blocking region and a viewing window, which is at least translucent to light, adjacent the light-blocking region and wherein the displayed video on the display is viewable through the viewing window of the overlay card.

14. The apparatus of claim 13, further comprising a web server accessible with the digital device to download a digital file providing the video image onto the digital device and wherein the video image is provided by the digital device playing the digital file with a media player.

15. The apparatus of claim 14, wherein the digital file is selected by the web server based on the overlay card or in response to user input indicating selection of one of a set of videos from a list displayed on the display of the digital device.

16. The apparatus of claim 13, wherein the viewing window is adapted to modify appearance of the displayed video image through color tinting, magnification, or frosting.

17. The apparatus of claim 13, wherein the overlay card comprises a body formed of substantially transparent material and a light-blocking layer formed of a substantially opaque material attached to a surface of the body and wherein the light-blocking layer comprises the light-blocking region and further comprises a void whose boundaries define outer edges of the viewing window.

18. An interactive display method, comprising:
receiving an image request from a digital device;
operating the digital device to display a list of videos;
processing a user selection for one of the videos for playing;
in response to the processing, updating the display with instructions to position an overlay card having a light-blocking region and a viewing window over the display; and
after a delay period, playing the user selected one of the videos to cause images to be displayed through the viewing window.

19. The method of claim 18, wherein the overlay card comprises a body formed of substantially transparent material and a light-blocking layer formed of a substantially opaque material attached to a surface of the body and wherein the light-blocking layer comprises the light-blocking region and further comprises a void whose boundaries define outer edges of the viewing window.

20. The method of claim 18, wherein the list of videos is selected based on a processing of the image request to determine an identification of the overlay card among a plurality of circulated overlay cards.
